(19) United States
(12) Patent Application Publication
(10) Pub. No.: US 2026/0120579 A1
(43) Pub. Date: Apr. 30, 2026

(54) MOBILITY ROUTE CONTROL SYSTEM AND METHOD

(71) Applicant: HYUNDAI AUTOEVER CORP., Seoul (KR)

(72) Inventors: Sang Min Jeon, Seoul (KR); Hun Dong Lee, Seoul (KR)

(73) Assignee: HYUNDAI AUTOEVER CORP., Seoul (KR)

(21) Appl. No.: 19/371,762

(22) Filed: Oct. 28, 2025

(30) Foreign Application Priority Data
Oct. 30, 2024 (KR) 10-2024-0150422

(51) Int. Cl. G08G 5/34; B64F 5/60; G07C 5/00; G07C 5/08; G08G 5/57; G08G 5/80

(52) U.S. Cl. CPC G08G 5/34; B64F 5/60; G07C 5/008; G07C 5/0808; G08G 5/57; G08G 5/80

(57) ABSTRACT

A mobility route control system includes an open diagnostic trouble code (DTC) module configured to convert a first DTC code generated within a first mobility vehicle into a first open DTC code. The mobility route control system also includes a wireless communication module configured to transmit the first open DTC code to one or more external devices and receive a second open DTC code transmitted from a second mobility vehicle. The mobility route control system additionally includes a route change control module configured to evaluate an impact of the second mobility vehicle on a route of the first mobility vehicle based on the second open DTC code and determine whether to change or maintain the route of the first mobility vehicle based on evaluation of the impact.

### CROSS REFERENCE TO RELATED APPLICATION

This application claims the benefit of and priority to Korea Patent Application No. 10-2024-0150422, filed on Oct. 30, 2024, the entire contents of which are hereby incorporated herein by reference.

### FIELD OF TECHNOLOGY

The present disclosure relates to a technique for controlling a route of a mobility vehicle.

### BACKGROUND

The statements in this section merely provide background information related to the present disclosure and may not constitute prior art.

The control of a route in mobility such as urban air mobility (UAM) is one of the core elements. In particular, preventing collisions with other mobility vehicles is a major technical task. By its nature of flying over urban areas, UAM requires management of interactions not only with ground traffic but also with other air mobility vehicles. To this end, a route control system needs to be provided with precise location detection, real-time data transmission, and traffic situation prediction functions.

The route control includes major elements in a broad sense. First, location information of the respective mobility vehicle is collected in real time through a sensor network, thereby identifying a current location and a speed of the respective mobility vehicle and calculating its predicted paths. Second, it is necessary to share the subject data with other mobility vehicles or ground control centers through a communication system. This communication needs to be high-speed and low-latency, allowing all mobility vehicles to know a location and planned paths of one another in real time. Further, a central control system or distributed autonomous control algorithm needs to analyze potential collision risks and modify paths accordingly.

In order to operate this route control system, many technical tasks need to be addressed. First, a standardized communication protocol is needed to ensure interoperability of a flight mobility. This allows mobility vehicles from different manufacturers to interact through the same information system. In addition, the algorithm for route control needs to consider a number of variables to plan and modify a flight path. Furthermore, it is an important task to increase the accuracy and reliability of this algorithm.

In addition, integration with ground infrastructure is essential for the UAM vehicle to control a route. In order to minimize interference with ground traffic when the UAM vehicle lands or takes off, linkage with ground traffic systems in the city center is necessary. To this end, integrated data sharing with the urban traffic management system needs to be achieved, through which the optimal flight path and landing point may be adjusted in real time.

However, all of these technical details are designed for situations where a mobility vehicle operates normally. The mobility vehicle receives route information from other mobility vehicles and sets a route that does not collide with other mobility vehicles. However, when other mobility vehicles operate abnormally, it becomes difficult to avoid collisions using this method alone. For example, when a specific mobility vehicle fails to transmit correct location information or behaves unexpectedly due to a communication error or system failure, the existing route control algorithm may have limitations in collision avoidance. In preparation for such cases, an auxiliary safety mechanism that may respond to abnormal situations is necessary, and each mobility vehicle needs to have the function capable of independently recognizing surrounding environment and performing immediate evasive maneuvers.

### SUMMARY

An aspect of the present disclosure provides a technique that enables one mobility vehicle to set a stable route using information received from another mobility vehicle. Another aspect of the present disclosure provides a technique that enables one mobility vehicle to check for abnormal information of another mobility vehicle and avoid dangerous situations such as collisions based on the abnormal information. Yet another aspect of the present disclosure provides a technique to standardize and share a non-standard diagnostic trouble code (DTC) code.

According to an embodiment, a mobility route control system is provided. The mobility route control system includes an open DTC module configured to convert a first DTC code generated within a first mobility vehicle into a first open DTC code. The mobility route control system also includes a wireless communication module configured to transmit the first open DTC code to one or more external devices and receive a second open DTC code transmitted from a second mobility vehicle. The mobility route control system additionally includes a route change control module configured to evaluate an impact of the second mobility vehicle on a route of the first mobility vehicle based on the second open DTC code and determine whether to change or maintain the route of the first mobility vehicle based on evaluation of the impact.

The mobility route control system may further include a safety monitoring module configured to recognize the second open DTC code, evaluate safety of the first mobility vehicle based on the second open DTC code, and provide an evaluation result to the route change control module.

A DTC code system of the first mobility vehicle, a DTC code system of the second mobility vehicle, and an open DTC code system may be different from one another.

The wireless communication module may be configured to add a first key value to the first open DTC code transmit the first open DTC code together with the first key value to the one or more external devices.

The open DTC module may be configured to verify the second open DTC code by comparing a second key value received together with the second open DTC code with a reference key value received in advance from an external server.

The wireless communication module may be configured to receive the first key value and the reference key value from the external server.

The one or both of the first key value or the reference key value may be generated by the external server differently based on a location and time of the first mobility vehicle or the second mobility vehicle.

The wireless communication module may be configured to change a reception period for receiving open DTC codes by the first mobility vehicle based on the second open DTC code.

The wireless communication module may be configured to change the reception period based on a number of open DTC codes received by the first mobility vehicle within a certain period of time.

The wireless communication module may be configured to transmit the first open DTC code to the one or more external devices by broadcasting the first open DTC code.

The wireless communication module may be configured to receive the second open DTC code through direct communication with the second mobility vehicle or through a central control device.

The wireless communication module may be configured to receive route information of the second mobility vehicle through communication with the second mobility vehicle.

According to another embodiment, a method for controlling a mobility route by a device is provided. The method includes converting a first diagnostic trouble code (DTC) code generated within a first mobility vehicle into a first open DTC code and transmitting the first open DTC code to one or more external devices. The method also includes receiving a second open DTC code transmitted from a second mobility vehicle. The method additionally includes evaluating an impact of the second mobility vehicle on a route of the first mobility vehicle based on the second open DTC code and determining whether to change or maintain the route of the first mobility vehicle based on evaluation of the impact.

The first open DTC code and/or the second open DTC code may include information on at least one issue among an engine and powertrain abnormality, an air pressure abnormality, a steering device system abnormality, an electrical system abnormality, a sensor abnormality, and an airbag system abnormality.

Transmitting the first open DTC code may include simultaneously transmitting the first open DTC code to a central control device and the other mobility vehicle.

Transmitting the first open DTC code to the one or more external devices may include transmitting a first key value together with the first open DTC code to the one or more external devices.

Transmitting the first open DTC code to the one or more external devices may include encrypting and transmitting a message in which the first open DTC code and the first key value are combined.

The first key value may be generated in a cloud device and shared with the first mobility vehicle and the second mobility vehicle.

The method may further include changing a reception period for receiving open DTC codes by the first mobility vehicle based on the second open DTC code.

According to yet another embodiment, a non-transitory medium storing computer-readable instructions is provided. The computer-readable instruction, when executed by a processor, cause the processor to convert a first diagnostic trouble code (DTC) code generated within a first mobility vehicle into a first open DTC code, transmit the first open DTC code to one or more external devices, receiving a second open DTC code transmitted from a second mobility vehicle, evaluate an impact of the second mobility vehicle on a route of the first mobility vehicle based on the second open DTC code, and determine whether to change or maintain the route of the first mobility vehicle based on evaluation of the impact.

As described above, in embodiments of the present disclosure, one mobility vehicle can set a stable route using information received from another mobility vehicle. In addition, according to embodiments of the present disclosure, one mobility vehicle can check abnormal information of the other mobility vehicle and avoid dangerous situations such as collisions based on the abnormal information. In addition, according to embodiments of the present disclosure, mobility vehicles can standardize and share non-standardized DTC codes.

### BRIEF DESCRIPTION OF THE DRAWINGS

In order to enable one having ordinary skill in the art to understand the present disclosure, various forms of the present disclosure are described given by way of example with reference to the accompanying drawings, in which:

FIG. 1 is a configuration diagram illustrating a mobility route control system according to an embodiment.

FIG. 2 is a diagram illustrating an example of a route change control of a mobility vehicle according to an embodiment.

FIG. 3 is a diagram illustrating information exchange between a mobility vehicle and a peripheral device according to an embodiment.

FIG. 4 is a diagram illustrating a process of encrypting and decrypting an open DTC code in a mobility vehicle according to an embodiment.

FIG. 5 is a diagram illustrating a cloud device changing a key value according to an embodiment.

FIGS. 6-8 are flowcharts of a first example of a mobility route control method according to an embodiment.

FIG. 9 is a flowchart of a second example of a mobility route control method according to an embodiment.

The drawings described herein are for illustration purposes only and are not intended to limit the scope of the present disclosure in any way.

### DETAILED DESCRIPTION

Hereinafter, embodiments of the present disclosure are described in detail with reference to accompanying drawings. It is noted that in assigning reference numerals to respective elements in the drawings, the same reference numerals designate the same elements even when the elements are shown in different drawings. Furthermore, in the following description, wherein it was determined that a detailed description of the related known functions and constructions would obscure the gist of the present disclosure, the detailed description thereof has been omitted.

Furthermore, in the following description, terms, such as the first, second, A, B, a, and b, may be used. However, the terms are used to only distinguish one element from the other element. The essence, order, and sequence of the elements are not limited by the terms. Furthermore, in the case in which one element is described to be “connected”, “coupled,” or “jointed” to another element, the one element may be directly connected or coupled to the other element, but it should be understood that a third element may be “connected”, “coupled,” or “jointed” between the two elements.

When a component, controller, device, element, apparatus, unit, module, or the like of the present disclosure is described as having a purpose or performing an operation, function, or the like, the component, controller, device, element, apparatus, unit, module or the like should be considered herein as being “configured to” meet that purpose or to perform that operation or function. Each component, controller, device, element, apparatus, unit, module and the like may separately embody or be included with a processor and a memory, such as a non-transitory computer readable media, as part of the apparatus.

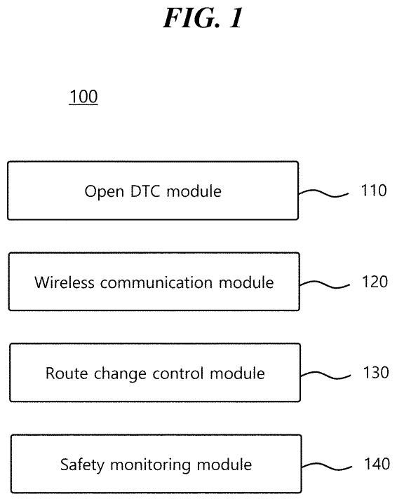

FIG. 1 is a configuration diagram illustrating a mobility route control system according to an embodiment.

Referring to FIG. 1, a mobility route control system 100 includes an open diagnostic trouble code (DTC) module 110, a wireless communication module 120, a route change control module 130, and a safety monitoring module 140. The DTC module 110, the wireless communication module 120, the route change control module 130, and the safety monitoring module 140 may be implemented by hardware, software, or a combination thereof. For example, each of the DTC module 110, the wireless communication module 120, the route change control module 130, and the safety monitoring module 140 may separately embody or be included with a processor and a memory, such as a non-transitory computer readable media, as part of the apparatus.

The open DTC module 110 may convert a diagnostic trouble code (DTC) code generated within a mobility vehicle into an open DTC code.

The DTC or DTC code is a code used to diagnose issues occurring in a mobility vehicle such as an automobile or an urban air mobility (UAM) vehicle. When an issue is detected in the electronic control unit (ECU) of the mobility vehicle, the DTC code is generated to help identify the cause and location of the issue.

DTC codes may be standardized by the manufacturer. For example, the first letter of the DTC code may indicate the system or function of the code. As an example, P may indicate the engine or powertrain, C may indicate brakes or steering, B may indicate airbags, doors, or air conditioners, and U may indicate network communication. In addition, other digits of the DTC code may indicate the detailed issue situation of the system or function as a predefined code.

DTC codes may be checked through a vehicle diagnostic device or scan tool. When an issue occurs, the vehicle diagnostic device or scan tool may quickly identify which part of the error occurred through the code.

DTC codes may be defined differently by manufacturers. Each manufacturer may define its own DTC codes according to their mobility vehicles, and the same code may have different meanings depending on the manufacturer. For example, a code called “P1401” may be defined as an exhaust gas circulation valve issue by manufacturer A, but may indicate a different issue by manufacturer B.

The open DTC module 110 may convert DTC codes that may be defined differently by manufacturers into standardized open DTC codes.

In an embodiment, the open DTC code may be a newly defined code adopted by a plurality of manufacturers, or a code adopted by a standardization organization such as the International Organization for Standardization (ISO) or the Society of Automotive Engineers (SAE). The ISO defines standardized DTC codes in ISO 15031-6, and the SAE defines standardized DTC codes in SAE J2012.

ISO 15031-6 standardizes and defines diagnostic codes related to vehicle emissions. In addition, ISO 15031-6 mainly deals with DTC codes used in an on-board diagnostics II (OBD-II) system that monitors the emissions, engine performance, and other important systems of a vehicle, and turns on a warning light and generates a DTC code when an issue is detected.

Unlike ISO 15031-6, SAE J2012 comprehensively covers issues that may occur in various electronic control systems of a vehicle including emissions.

Open DTC codes may convert DTC codes defined by different DTC code systems by each manufacturer into standardized codes, such as codes defined in ISO 15031-6, codes defined in SAE J2012, or other standardized codes.

The wireless communication module 120 may transmit the open DTC code to the outside.

The wireless communication module 120 used in mobility devices such as a vehicle and UAM vehicle includes a cellular communication module, a vehicle-to-everything (V2X) module, a wireless fidelity (Wi-Fi) and a Bluetooth module.

The cellular communication module enables data communication between a vehicle and an external network. This module is used to transmit data between a system within a mobility vehicle and a cloud device, and may support various functions such as an information system within the mobility vehicle, remote diagnosis, and over-the-air (OTA) software update. Cellular communication is mainly based on fourth generation long-term evolution (4G LTE) and fifth generation (5G) technology, and may provide fast data transmission speed and wide service coverage. In particular, 5G may be suitable for large-capacity data transmission for autonomous driving functions of vehicles owing to availability of low-latency and high-speed data transmission.

The V2X module may support communication between mobility vehicles (V2V), mobility vehicles and infrastructure (V21), mobility vehicles and pedestrians (V2P), and mobility vehicles and networks (V2N). This technology is mainly designed to improve the safety of a mobility vehicle and alleviate traffic congestion. V2X communication is advantageous for real-time data exchange that requires low latency, and may be used to improve the traffic environment, especially through collision avoidance between mobility vehicles and interaction with traffic lights and road signs. V2X communication includes the conventional dedicated short-range communication (DSRC) and the recent cellular V2X (C-V2X) method, and C-V2X may utilize the range and connectivity of cellular networks.

Wi-Fi and Bluetooth modules may play a role in short-range communication within mobility vehicles. The Wi-Fi module may form an internal network of the mobility vehicle, connect to various devices, or provide Internet access as a mobile hotspot.

The following description focuses on an example in which the wireless communication module 120 is a V2X module, but the present disclosure is not limited thereto.

The wireless communication module 120 may transmit an open DTC code to another mobility vehicle or a central control device through direct communication of V2X. In V2X technology, a signal may be directly transmitted to a specific other mobility vehicle or the central control device. This method may be mainly used in mobility vehicle-to-mobility vehicle (V2V) communication or mobility vehicle-to-infrastructure (V21) communication.

The wireless communication module 120 may transmit an open DTC code to the other mobility vehicle or the central control device through broadcasting. Instead of transmitting signals to a specific device, V2X technology may use a broadcasting method that transmits information to all devices within a specific range.

The wireless communication module 120 may receive an open DTC code transmitted from a wireless communication module of the other mobility vehicle.

The wireless communication module 120 may receive an open DTC code transmitted through direct communication from another mobility vehicle or by broadcasting. Alternatively, the wireless communication module 120 may receive an open DTC code through the central control device. The central control device may relay an open DTC code transmitted from the other mobility vehicle.

The wireless communication module 120 may receive route information from the other mobility vehicle. A mobility vehicle may receive route information from the other mobility vehicle and may set and control its own route by synthesizing the same with its own destination information.

The safety monitoring module 140 may recognize the open DTC code received from the other mobility vehicle, evaluate the impact on the safety of its own mobility vehicle, and generate the evaluation result.

The safety monitoring module 140 may receive data from sensors included in the mobility vehicle or an electronic control device that manages the sensors to monitor the safety of flight. For example, the safety monitoring module 140 may monitor various pieces of data such as speed, altitude, direction, air pressure, temperature, and humidity generated during flight in real time and evaluate the impact of the values on the safety of the flight.

The safety monitoring module 140 continuously inspects the operating status of the main equipment of the mobility vehicle, such as the engine, battery, electronic devices, and communication system, and monitors the structural state of an airframe, the temperature of parts, and the power consumption, so as to quickly recognize overheating or abnormal consumption of specific parts.

In addition, the safety monitoring module 140 may detect and analyze the surrounding environment of the airframe to prevent collision with other mobility vehicles or obstacles. The safety monitoring module 140 may use sensors such as radar and cameras to identify the surrounding situation in real time. When an object approaching abnormally is detected, the safety monitoring module 140 may determine the risk of collision and deliver the same to the route change control module 130.

As part of such safety-related analysis, the safety monitoring module 140 may recognize the open DTC code received from the other mobility vehicle, evaluate the safety of the airframe, and deliver the evaluation results to the route change control module 130.

In addition, the route change control module 130 may evaluate the impact of an other mobility vehicle on its route through open DTC codes received from the other mobility vehicle and decide to change or maintain the route.

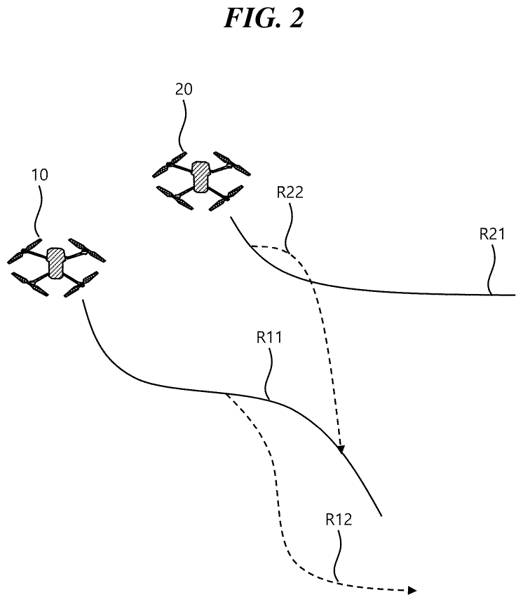

FIG. 2 is a diagram illustrating an example of a route change control of a mobility vehicle according to an embodiment.

Referring to FIG. 2, a first mobility vehicle 10 may exchange route information with a second mobility vehicle 20 and may set route 1-1 considering its destination. In addition, the second mobility vehicle 20 may set route 2-1 considering the route information of the first mobility vehicle 10 and its destination. According to this route setting, the first mobility vehicle 10 and the second mobility vehicle 20 may operate without collision in a normal operating situation.

In addition, the first mobility vehicle 10 and the second mobility vehicle 20 may convert the DTC code generated internally into an open DTC code periodically or non-periodically and then transmit the same to the outside. According to this open DTC code, the first mobility vehicle 10 may check whether the second mobility vehicle 20 is abnormal, and the second mobility vehicle 20 may check whether the first mobility vehicle 10 is abnormal.

In an example, an abnormality may occur in the second mobility vehicle 20 at one point in time. Then, the second mobility vehicle 20 may not operate normally along the originally planned route 2-1, and may operate along route 2-2 due to a crash or emergency operation.

Then, the abnormal situation of the second mobility vehicle 20 may be delivered to the first mobility vehicle 10 through the open DTC code. Then, the first mobility vehicle 10 may identify the abnormal situation of the second mobility vehicle 20 according to the open DTC code, identify the emergency operation range of the second mobility vehicle 20, and then change the route to route 1-2 to get out of the range.

Other devices may also be involved in the exchange of the open DTC code and route change control.

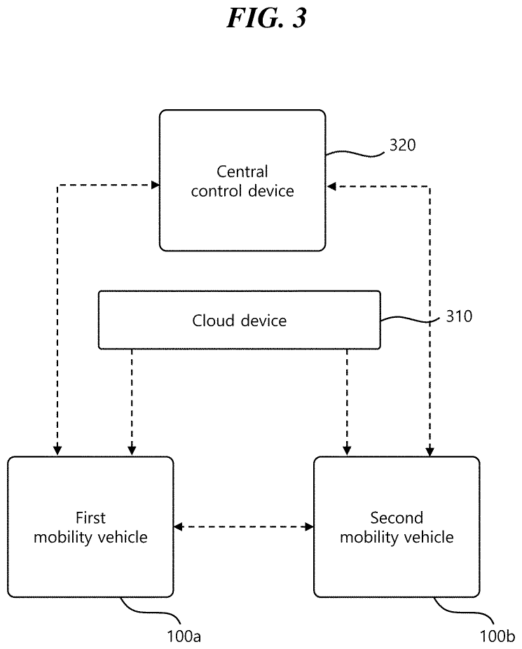

FIG. 3 is a diagram illustrating information exchange between a mobility vehicle and a peripheral device according to an embodiment.

Referring to FIG. 3, a first mobility vehicle 100a and a second mobility vehicle 100b may communicate with a could device 310 and a central control device 320.

The first mobility vehicle 100a and the second mobility vehicle 100b may receive route information of other mobility vehicles from the central control device 320. In addition, the first mobility vehicle 100a and the second mobility vehicle 100b may receive information on a route authorized by the central control device 320 from the central control device 320. In addition, the first mobility vehicle 100a and the second mobility vehicle 100b may synthesize these pieces of information to set their own routes.

The first mobility vehicle 100a and the second mobility vehicle 100b may periodically transmit flight state information such as the current location, altitude, and speed to the central control device 320. Thus, the central control device 320 may identify the exact location of the mobility vehicle and track the path in real time. When the first mobility vehicle 100a and the second mobility vehicle 100b require a flight path plan or a change in destination, the central control device 320 may transmit a new flight path.

The first mobility vehicle 100a and the second mobility vehicle 100b may transmit data related to the state of the airframe such as the engine state, remaining battery level, and fuel state to the central control device 320. In addition, the first mobility vehicle 100a and the second mobility vehicle 100b may transmit the open DTC code to the central control device 320. The central control device 320 may check the real-time health state of the mobility vehicle by synthesizing these pieces of information and help to respond quickly when an unexpected issue occurs.

In addition, the central control device 320 may transmit real-time weather data to the first mobility vehicle 100a and the second mobility vehicle 100b and may also transmit ground traffic conditions to the first mobility vehicle 100a and the second mobility vehicle 100b.

The cloud device 310 may store a key value shared by the first mobility vehicle 100a and the second mobility vehicle 100b.

The first mobility vehicle 100a and the second mobility vehicle 100b may encrypt the open DTC code by adding a key value thereto and then transmit the same to the outside. Then, the first mobility vehicle 100a and the second mobility vehicle 100b may decrypt the received message using the key value and then check the open DTC code.

The first mobility vehicle 100a and the second mobility vehicle 100b may download the key value from the cloud device 310. Then, the first mobility vehicle 100a and the second mobility vehicle 100b may add the key value to the open DTC code. In addition, when receiving the open DTC code, the first mobility vehicle 100a and the second mobility vehicle 100b may verify whether the open DTC code is normal by comparing the key value received with the open DTC code with the key value downloaded from the cloud device 310.

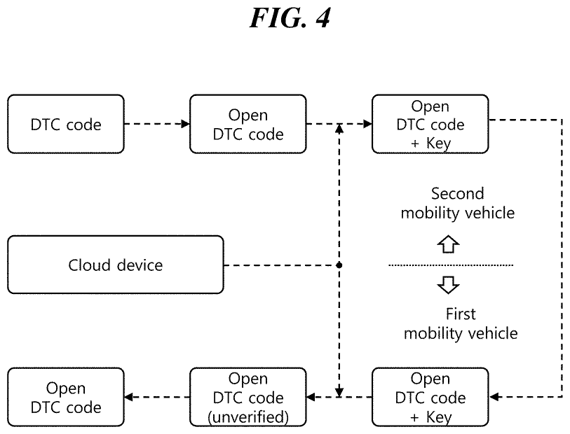

FIG. 4 is a diagram illustrating a process of encrypting and decrypting an open DTC code in a mobility vehicle according to an embodiment.

Referring to FIG. 4, the second mobility vehicle may generate a DTC code while monitoring the internal state. In addition, the second mobility vehicle may convert the generated DTC code into an open DTC code.

The second mobility vehicle may download a key value from the cloud device before or after generating the open DTC code. Typically, the second mobility vehicle may download the key value from the cloud device along with the start-up.

The second mobility vehicle may encrypt the open DTC code by adding a key value to the converted open DTC code. In addition, the second mobility vehicle may broadcast an encrypted message, which is a message including the open DTC code and the key value, to the outside.

The first mobility vehicle may receive an encrypted message from the second mobility vehicle and/or the central control device. The encrypted message may include the open DTC code and the key value.

The first mobility vehicle may download the key value from the cloud device before or after receiving the encrypted message. Typically, the first mobility vehicle may download the key value from the cloud device along with the start-up.

The first mobility vehicle may decrypt the encrypted message using the key value received from the cloud device. In addition, the first mobility vehicle may verify the open DTC code by comparing the key value included in the received message with the key value downloaded from the cloud device.

The key value may be changed according to time and location.

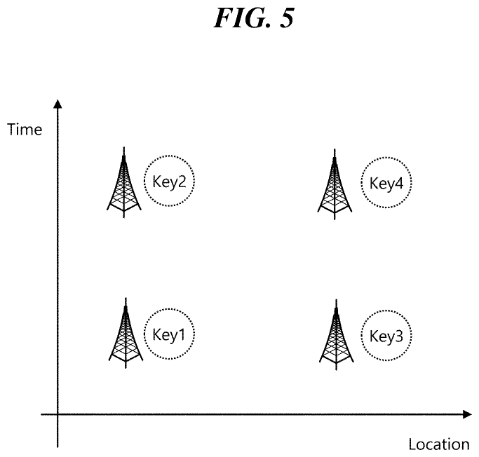

FIG. 5 is a diagram illustrating a cloud device changing a key value according to an embodiment.

Referring to FIG. 5, the cloud device may provide a key value by changing the same according to the location and time of the mobility vehicle.

The key value generated by the cloud device may be dynamically changed according to the time and location. In order to realize this, dynamic key management and location-based encryption technology may be used.

Time-based key change may be a method of generating a new key value according to a specific time interval and delivering the same to two mobility vehicles in a synchronized manner. For example, a new key value may be assigned periodically, such as every 5 minutes, 30 minutes, or 1 hour, and used for encryption and decryption. The time-based key change requires time synchronization between the cloud device and the mobility vehicle, and to this end, accurate time information may be synchronized through a time protocol such as network time protocol (NTP). When attempting communication through the time-based key change, both sides perform encryption and decryption using the same key.

Location-based key change may be a method of generating a location-dependent key value in the cloud based on the current location information of the mobility vehicle. By using a key value that is valid only in a specific geographical area, messages may be made indecipherable outside the area. For example, when a mobility vehicle enters a specific area, a key exclusive to the area may be assigned, and when the mobility vehicle leaves the area, a new key value may be replaced. Periodic location information exchange occurs between the cloud and the mobility vehicle, and this may synchronize key value changes in the same location. This method enables communication in a specific geographical area to be performed more securely.

A key management method that simultaneously considers time and location may also be implemented. For example, this method doubles security by generating a key that is valid only in a specified area at a specific time zone. The cloud device may check the current location of the mobility vehicle at regular time intervals and generate and distribute a unique key value based on the corresponding time and location. This method may be set so that a mobility vehicle moving along a fixed path may communicate using a key value that is valid only when it is in a specified area at a specific time zone. This method allows for implementation of a sophisticated encryption policy based on both time and location.

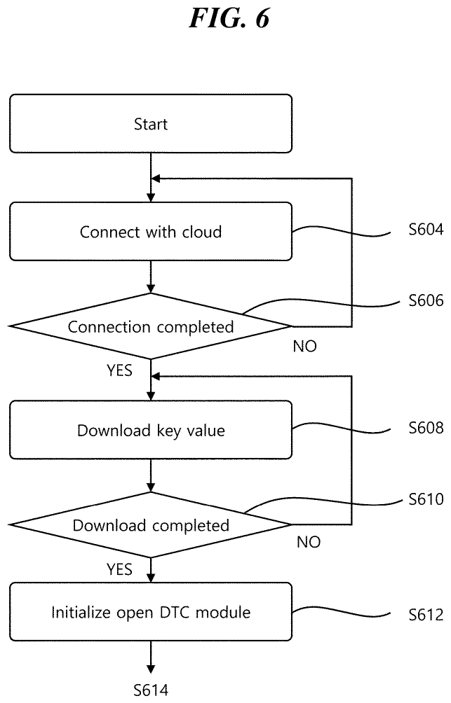

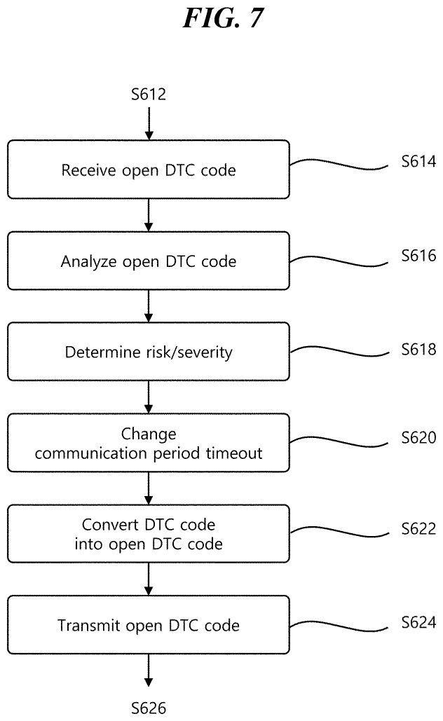

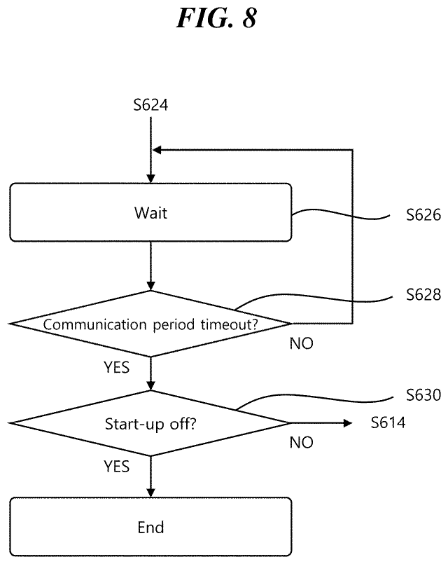

FIGS. 6-8 are flowcharts of a first example of a mobility route control method according to an embodiment.

Referring to FIGS. 6-8, the device, for example, the mobility route control system, may start operation with the start-ON of the mobility vehicle.

In an operation S604, the device may attempt to connect with the cloud device. In an operation S606, the device may determine whether the connection with the cloud device is completed, and when the connection is not completed (NO in the operation S606), the device may retry connecting and determining whether the connection with the cloud device is completed in the operation S606.

When the connection with the cloud device is completed (YES in the operation S606), the device may download a key value from the cloud device in an operation S608. In an operation S610, the device may determine whether the download of the key value is completed, and when the download of the key value is not completed (NO in the operation S610), the device may retry downloading the key in the operation S608.

When the download of the key value is completed (YES in the operation S610), the device may initialize the open DTC module in an operation S612.

In an operation S614, the device may receive an open DTC code from the outside, for example, the other mobility vehicle or the central control device.

In an operation S616, the device may analyze the open DTC code. The open DTC code may include information on at least one issue among engine and powertrain abnormalities, gas pressure abnormalities, steering system abnormalities, electrical system abnormalities, sensor abnormalities, and airbag system abnormalities.

In an operation S618, the device may determine the impact of the other mobility vehicle on its own mobility vehicle through analysis of the open DTC code. For example, the device may determine the risk and/or severity of the impact. The device may determine the risk and/or severity based on the number of open DTC codes received from the outside within a certain period of time. For example, when the number of open DTC codes received within a certain period of time is greater than a reference number, the device may set the risk or severity to a high level.

In an operation S620, the device may change the reception period of the open DTC codes received from the outside according to the risk and/or severity determination result. The device may change, for example, the communication period timeout for receiving the open DTC code according to the risk and/or severity determination result. The device may change the reception period of the open DTC codes received from the outside by the wireless communication module according to the number of open DTC codes received from the outside within a certain period of time.

In addition, the device may evaluate the impact of the other mobility vehicle on the route of the corresponding mobility vehicle through the received open DTC code and decide to change or maintain the route of the corresponding mobility vehicle.

The device may generate an open DTC code for the other mobility vehicle and transmit the same to the outside. The device may convert the DTC code generated internally into the open DTC code in an operation S622 and may transmit the converted open DTC code to the outside in an operation S624. The device may simultaneously transmit the converted open DTC code into the central control device and the other mobility vehicle.

In an operation S626, the device may wait for the reception of the open DTC code from the other mobility vehicle. In an operation 628, the device may wait for a certain communication period timeout. When the communication period timeout has not been reached (NO in an operation S628), the device may continue to wait. When the communication period timeout has been reached (YES in the operation S628), the device may proceed to an operation 630 to determine whether start-up is in an OFF state.

When the start-up is not in an OFF state (NO in the operation S630), the device may return to the operation S614.

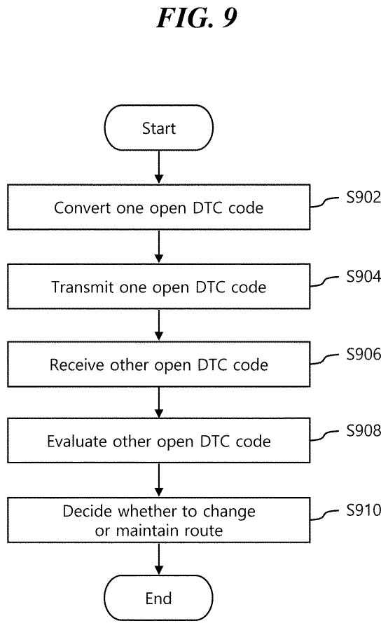

FIG. 9 is a flowchart of a second example of a mobility route control method according to an embodiment.

Referring to FIG. 9, in an operation S902, the device, for example, the mobility route control system, may convert a first DTC code generated within a first mobility vehicle into a first open DTC code.

In an operation S904, the device may transmit the first open DTC code to the outside (e.g., to one or more external device). For example, the device may broadcast the first open DTC code via a network. The first open DTC code may be transmitted simultaneously to the central control device and the other mobility vehicle.

When transmitting the first open DTC code to the outside, the device may transmit a key value together with the one open DTC code to the outside. For example, the device may encrypt and then transmit a message combining the one open DTC code and the key value. In an embodiment, the key value may be generated in an external server, for example, a cloud device, and shared with the corresponding mobility vehicle and the other mobility vehicle.

In an operation S906, the device may receive the a second open DTC code transmitted from a second mobility vehicle.

In an embodiment, the first open DTC code and/or the second open DTC code may include information on at least one issue among engine and powertrain abnormalities, gas pressure abnormalities, steering system abnormalities, electrical system abnormalities, sensor abnormalities, and airbag system abnormalities.

In an operation S908, the device may evaluate the impact of the second mobility vehicle on a route of the first mobility vehicle based on the second open DTC code. In an embodiment, the device may change the reception period of open DTC codes received by the first mobility vehicle from the outside based on the other open DTC code.

In addition operation S910, the device may determine whether to change or maintain the route of the first mobility vehicle based on the result of evaluation of the impact of the second mobility vehicle on the route of the first mobility vehicle.

Embodiments of the present disclosure described above may be implemented in the form of a computer program that may be executed through various components on a computer, and such a computer program may be recorded on a computer-readable medium. In this connection, examples of the medium include magnetic media, such as a hard disk, a floppy disk, and a magnetic tape, optical recording media, such as CD-ROM and DVD, magneto-optical media such as a floptical disk, and hardware devices specifically configured to store and execute program instructions, such as ROM, RAM, and a flash memory.

As described above, in embodiments of the present disclosure, one mobility vehicle may set a stable route using information received from another mobility vehicle. In addition, according to embodiments of the present disclosure, one mobility vehicle may check abnormal information of the other mobility vehicle and avoid dangerous situations such as collisions based on the abnormal information. In addition, according to embodiments of the present disclosure, mobility vehicles may standardize and share non-standardized DTC codes.

The term “comprises,” “includes,” or “has” as used herein should be interpreted not to exclude other elements but to further include such other elements since the corresponding elements may be inherent unless mentioned otherwise. All terms including technical or scientific terms have the same meanings as generally understood by a person having ordinary skill in the art to which the present disclosure pertains unless mentioned otherwise. Generally used terms, such as terms defined in a dictionary, should be interpreted as coinciding with meanings of the related art from the context. It should be understood that terms should not be interpreted in an idealized or overly formal sense unless expressly so defined herein.

Hereinbefore, although the technical ideas of the present disclosure have been described for illustrative purposes, a person having ordinary skill in the art to which the present disclosure pertains should appreciate that various modifications and variations are possible, without departing from the spirit and essential characteristics of the present disclosure. Therefore, the embodiments of the present disclosure are described only for illustrative purposes and should not be construed as limiting the technical ideas of the present disclosure. The scope of protection of the present disclosure should be determined on the basis of the descriptions in the appended claims, and all technical ideas within the scope of equivalents thereof should be construed as being included in the scope of right of the present disclosure.

What is claimed is:

1. A mobility route control system comprising:
an open diagnostic trouble code (DTC) module configured to convert a first DTC code generated within a first mobility vehicle into a first open DTC code;
a wireless communication module configured to transmit the first open DTC code to one or more external devices and receive a second open DTC code transmitted from a second mobility vehicle; and
a route change control module configured to evaluate an impact of the second mobility vehicle on a route of the first mobility vehicle based on the second open DTC code and determine whether to change or maintain the route based on evaluation of the impact.

2. The mobility route control system of claim 1, further comprising a safety monitoring module configured to:
recognize the second open DTC code;
evaluate safety of the first mobility vehicle based on the second open DTC code; and
provide an evaluation result to the route change control module.

3. The mobility route control system of claim 1, wherein a DTC code system of the first mobility vehicle and a DTC code system of the second mobility vehicle are different from each other.

4. The mobility route control system of claim 1, wherein the wireless communication module is configured to add a first key value to the first open DTC code and transmit the first open DTC code together with the first key value to the one or more external devices.

5. The mobility route control system of claim 4, wherein the open DTC module is configured to verify the second open DTC code by comparing a second key value received together with the second open DTC code with a reference key value received in advance from an external server.

6. The mobility route control system of claim 5, wherein the wireless communication module is configured to receive the first key value and the reference key value from the external server.

7. The mobility route control system of claim 6, wherein one or both of the first key value or the reference key value is generated by the external server differently based on a location and time of the first mobility vehicle or the second mobility vehicle.

8. The mobility route control system of claim 1, wherein the wireless communication module is configured to change a reception period for receiving open DTC codes by the first mobility vehicle based on the second open DTC code.

9. The mobility route control system of claim 8, wherein the wireless communication module is configured to change the reception period based on a number of open DTC codes received within a certain period of time.

10. The mobility route control system of claim 1, wherein the wireless communication module is configured to transmit the first open DTC code to the one or more external devices by broadcasting the first open DTC code.

11. The mobility route control system of claim 1, wherein the wireless communication module is configured to receive the second open DTC code through direct communication with the second mobility vehicle or through a central control device.

12. The mobility route control system of claim 1, wherein the wireless communication module is configured to receive route information of the second mobility vehicle through communication with the second mobility vehicle.

13. A method for controlling a mobility route by a device, the method comprising:
converting a first diagnostic trouble code (DTC) code generated within a first mobility vehicle into a first open DTC code;
transmitting the first open DTC code to one or more external devices;
receiving a second open DTC code transmitted from a second mobility vehicle;
evaluating an impact of the second mobility vehicle on a route of the first mobility vehicle based on the second open DTC code; and
determining whether to change or maintain the route of the first mobility vehicle based on evaluation of the impact.

14. The method of claim 13, wherein one or both of the first open DTC code or the second open DTC code includes information on at least one issue among an engine and powertrain abnormality, an air pressure abnormality, a steering device system abnormality, an electrical system abnormality, a sensor abnormality, and an airbag system abnormality.

15. The method of claim 13, wherein transmitting the first open DTC code to the one or more external devices includes simultaneously transmitting the first DTC code to a central control device and the second mobility vehicle.

16. The method of claim 13, wherein transmitting the first open DTC code to the one or more external devices includes transmitting a first key value together with the first open DTC code to the one or more external devices.

17. The method of claim 16, wherein transmitting the first open DTC code includes transmitting a message in which the first open DTC code and the first key value are combined and encrypted.

18. The method of claim 17, wherein the first key value is generated in a cloud device and is shared with the first mobility vehicle and the second mobility vehicle.

19. The method of claim 13, further comprising changing a reception period for receiving open DTC codes by the first mobility vehicle based on the second open DTC code.

20. A non-transitory medium storing computer-readable instructions that, when executed by a processor, cause the processor to:
convert a first diagnostic trouble code (DTC) code generated within a first mobility vehicle into a first open DTC code;
transmit the first open DTC code to one or more external devices;
receive a second open DTC code transmitted from a second mobility vehicle;
evaluate an impact of the second mobility vehicle on a route of the first mobility vehicle based on the second open DTC code; and
determine whether to change or maintain the route of the first mobility vehicle based on evaluation of the impact.
